(19) United States
(12) Patent Application Publication
(10) Pub. No.: US 2007/0018574 A1
(43) Pub. Date: Jan. 25, 2007

(54) Light source for high efficiency illumination systems

(76) Inventors: Andrew Davies, Hinckley (GB); Roger Alan Hume, Melton Mowbray (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/476,489

(22) Filed: Jun. 28, 2006

(30) Foreign Application Priority Data
Jul. 25, 2005 (GB) 0515217.8

(51) Int. Cl. H01J 19/42; H01K 1/50

(52) U.S. Cl. 313/578; 313/264

(57) ABSTRACT

A filament array for an incandescent lamp comprises a plurality of helically-coiled filament sections (7-10), which are arranged in one or more planes. The filament sections are of varying lengths whereby the array approximates the cross-sectional shape of the light beam which is to be projected by the lamp, as indicated for example by the circle (11).

### BACKGROUND OF THE INVENTION

This invention relates generally to illumination systems, and particularly to systems which utilise a spherical or near-spherical reflector for collecting light from a suitable source, and projecting it forward to produce a high intensity beam of light. In systems of this type, the light source is positioned in front of the reflector with its centroid at the reflector's focal point. Light is thus projected forward either directly from the source, or after reflection by the reflector. It is then necessary to manipulate the projected light to produce a beam with certain desired characteristics, by using a combination of lenses, apertures and other optical devices depending upon the desired beam characteristics.

Illumination systems which utilise spherical or near-spherical reflectors can be divided into several categories, depending upon the characteristics of the beam they produce, and upon their means of producing the beam. There are many such systems, the three most common examples being Fresnel, pebble convex and condenser optics. Each of these will now be described in turn:

Fresnel and pebble convex illumination systems may both be described as follows: A light source is positioned in front of a spherical or near-spherical reflector with the centroid of the light source at the reflector's focal point. Rays of light are projected forward towards a lens. In most commercial embodiments of systems of this type, the light source and reflector are mounted such that the distance between the light source and the lens can be varied mechanically by means of a suitable mechanism. The lens contains detail in its design which determines the type of beam emitted by the illumination system. It is the detail of the lens design which determines whether the system belongs to the Fresnel or pebble convex family. Fresnel systems typically give smooth beams with very soft edges, whereas pebble convex systems give similar smoothness, but with a harder, more well-defined edge.

In recent years attempts have been made to develop luminaires which combine the functionality of traditional Fresnel fixtures with higher beam efficacies (beam efficacy—lumens in beam per watt of power consumed). However, such luminaires retail at a higher cost to the end user compared to traditional Fresnel fixtures. Moreover, the increased beam efficacy is often achieved at the expense of some other functionality, for example a limitation in the range of beam angles available to the user.

It will be understood, therefore, that there is a need for traditional Fresnel and pebble convex lighting fixtures which retain the current functionality of traditional fixtures whilst at the same time delivering increased beam efficacies. It will be further understood that there is a need for a lamp which could be plugged into existing fixtures and give rise to increased beam efficacies without the need to invest in new luminaires.

A typical condenser optics system can be described as follows: This system has the same combination of light source and reflector as described above. However, in this case a condenser lens is positioned close to and in front of the light source. The condenser lens refracts the projected light such that it condenses to a point. An aperture, also commonly known as a “gate”, is positioned close to the point at which the rays of projected light converge. The gate controls the size and shape of the beam of light, and imparts to it a well-defined “hard” edge. Once the light beam has passed through the gate, a number of devices may be used to impart desired characteristics to the beam. For example, two lenses are commonly employed, which may be moved relative to each other to change the spread of the beam, and vary the degree of softness at the beam edge. Other devices which are commonly used include shutters, which can shape the beam, coloured filters, which colour the beam, or gobos, which allow the optical system to project images onto a suitable backdrop or screen.

Condenser optics systems typically give smoother beams of better quality than the alternative approach using an ellipsoidal reflector. However, recent advances in ellipsoidal systems have led to them being preferred in many applications, mainly because the more modern systems operate at higher beam efficacies than conventional condenser optics systems.

It will be understood, therefore, that there is a need for a lamp which can be used in condenser optics fixtures where it would facilitate better beam efficacies than are currently available, whilst retaining the high quality beam distributions for which condenser optics fixtures are well-known. It would be desirable to increase beam efficacies of condenser optics fixtures to levels comparable with, and preferably exceeding, those of ellipsoidal fixtures.

In most lighting systems of the types described herein, the aperture through which the beam of light has to pass is circular in shape. This applies whether the fixture belongs to the Fresnel or pebble convex families (where the aperture takes the form of a lens), or whether the fixture uses condenser optics (where the aperture takes the form of a gate). This fact will be understood by those skilled in the art since a circular beam is the most useful to lighting designers and practitioners. Nevertheless, in a small minority of specialist cases, it may also be desirable to project beams which are non-circular in shape.

Light sources which are typically used in fixtures such as those described herein can be divided into two families: incandescent and discharge. A typical incandescent source may comprise a multiplicity of helically wound coils. These coils are of equal length, are arranged substantially parallel with each other, and are linked together in series via linking sections, referred to herein as loops. The coils are typically arranged in a series of one or more parallel planes. Where one plane of coils is present, the array is known as a monoplane. Where two parallel planes exist, the array is known as a biplane, and so on. In principle, any number of planes of coils may be employed as is desirable. Since the coils are of equal length, the overall shape of the filament array, when viewed face-on from the reflector, is square or rectangular.

Clearly, all known light sources available for use in Fresnel, pebble convex, condenser and related lighting systems have shapes which do not match the desired shape of the beam, which as we have already seen is determined by the aperture through which the light beam is to be projected. For example, if a square light source is used, the light emitted from the light source/reflector combination would be substantially square in pattern. When this light is passed through a circular aperture, situations may arise as are depicted in FIGS. 1-3. In FIG. 1, the square beam of light emitted by the filament 1 completely fills the aperture 2. However, a substantial proportion of the available light, emitted from the corners of the filament 3 misses the aperture and is wasted. This has the effect of reducing the beam efficacy.

In FIG. 2, the size of the light source 4 has been reduced such that the light beam emitted from it fits completely within the area defined by the aperture 2. This has the desirable effect of maximising the amount of light which is passed through the aperture. However, this apparent advantage is achieved at a price, since not all of the aperture is filled with light. There are areas 5 where there is a deficiency of light in the beam. In cases such as this, although the beam will be circular in shape, its smoothness will be compromised by the presence of dark patches which correspond to the areas where the aperture has not been filled.

In FIG. 3, a rectangular beam of light 6 is shown with a circular aperture 2 indicated. In this case, there is a small amount of light wasted at the respective ends of the source 3, but in addition, there are also substantial regions of unfilled aperture 5 which will again appear as dark patches in the projected beam.

It will be understood from the above that there is a need for a light source which overcomes these disadvantages.

### BRIEF DESCRIPTION OF THE INVENTION

According to the present invention, there is provided a filament array for an incandescent lamp comprising a plurality of helically-coiled filament sections, the sections being arranged in one or more planes, characterised in that the filament sections are of varying lengths whereby the array approximates the cross-sectional shape of the light beam which is to be projected by the lamp.

The present invention is preferably embodied in a lamp adapted for use with a spherical, or near-spherical reflector in producing a high-intensity beam of light. The beam of light will be projected through an aperture in an arrangement similar to those described above. In most commercial embodiments of this invention, it is envisaged that the aperture is circular in shape, although the invention also contemplates provision for non-circular shaped beams.

The lamp comprises a light source which, when viewed from a position perpendicular to the reflector and the aperture, has a shape substantially similar to the aperture.

The filament typically comprises an array of helically wound coils of unequal length arranged substantially parallel to each other. The coils are arranged in one or more parallel planes spaced apart along the longitudinal axis of the lamp. When the filament is viewed from a position perpendicular to these planes, its 2-dimensional appearance resembles a shape substantially similar to that of the aperture of the lighting fixture in which the lamp is to be used.

### BRIEF DESCRIPTION OF THE DRAWINGS

Embodiments of the invention will now be described, by way of example, with reference to the accompanying drawings, in which:

FIG. 1 shows a known filament array and its relationship to a first circular aperture substantially within the boundary of the array;

FIG. 2 shows a known filament array and its relationship to a second circular aperture which substantially contains the whole array;

FIG. 3 shows a light beam of rectangular cross-section and its relationship to a circular aperture;

FIG. 4 shows a filament array in accordance with the invention, and its relationship to a circular aperture; and

FIGS. 5 and 6 show a front elevation and cross-section of a lamp containing a filament array according to the invention and a part-spherical reflector.

### DETAILED DESCRIPTION OF THE INVENTION

A typical embodiment of this invention wherein the light source is an incandescent filament will now be described further with reference to FIG. 4. This shows a view of an incandescent filament array of the monoplane type, in accordance with this invention, as would be viewed from a position perpendicular to the spherical reflector.

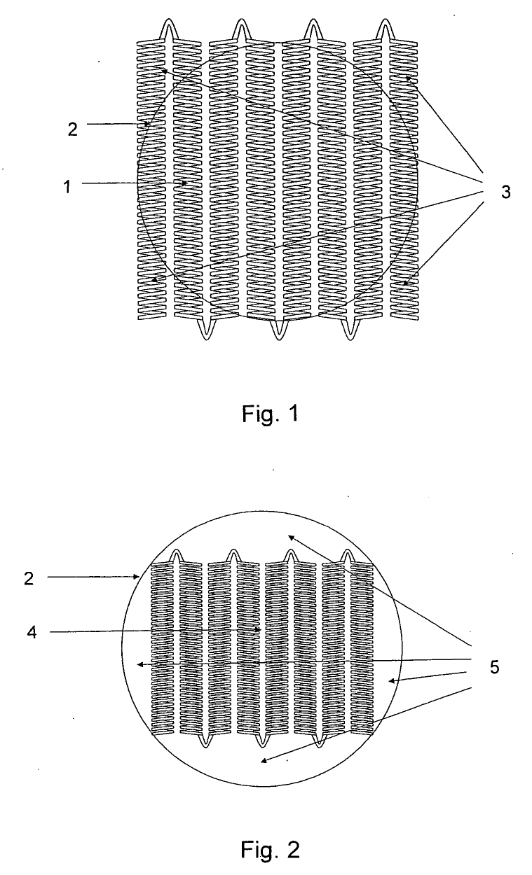

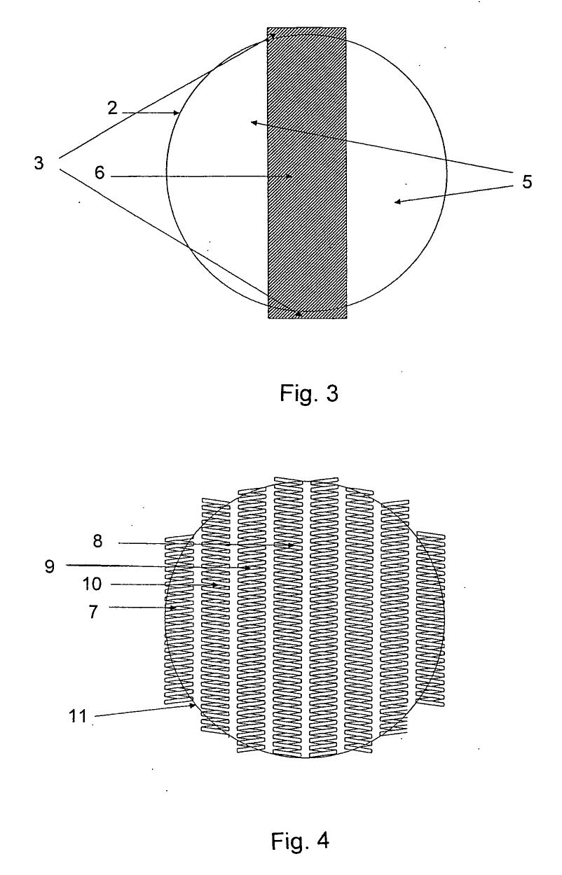

Referring to FIG. 4, it can be seen that the filament array comprises eight parallel helically-wound sections of coil. The outer filament sections 7 are substantially shorter than the inner sections 8, with the intermediate sections 9, 10 between the outer and inner sections having intermediate lengths. Also shown on this diagram is a circle 11 which represents the aperture through which light emitted from this filament array would have to pass. It can be seen that each section has a length that exceeds the boundary of the circle. The proportion of the filament which would emit light that would not pass through the aperture, and would therefore be wasted, corresponds to that area of the filament which falls outside of the circle. It can be seen that the proportion of wasted light emitted by the filament shown in FIG. 4 is considerably less than that emitted by traditional filament arrays, for example those shown in FIGS. 1-3. Therefore, it will be understood that a filament array in accordance with this invention is more efficient than existing arrays.

Although the example used herein is that of a monoplane filament, it will be understood that this invention is equally applicable to a biplane filament array, and even filament arrays with more than two planes. A monoplane filament array is often the preferred embodiment when used with Fresnel and pebble convex optics, whereas a biplane array is usually preferred for condenser optics applications when a more compact source size is desired.

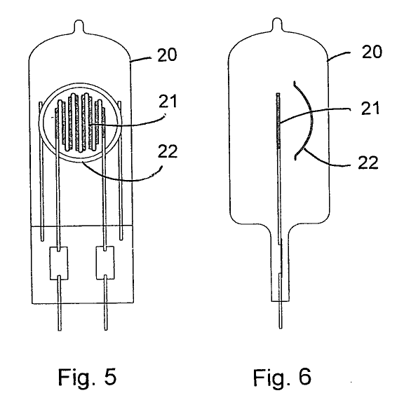

The filament arrays of this invention may also be employed in lamps with suitable integral optics, such as a sealed beam lamp (e.g. PAR64), a MR-series reflector lamp (e.g. MR-16) or a lamp with a suitable internal proximity reflector (e.g. BVE). One possible configuration is shown in FIGS. 5 and 6, where a lamp 20 contains a filament array 21 in accordance with the invention, mounted in front of a part-spherical reflector 22. The filament array is of generally circular shape, thereby optimizing the efficacy of the lamp.

The invention has been described with reference to the preferred embodiments. Obviously, modifications and alterations will occur to others upon reading and understanding the preceding detailed description. It is intended that the invention be construed as including all such modifications and alterations.

What is claimed is:

1. Filament array for an incandescent lamp comprising a plurality of helically-coiled filament sections, the sections being arranged in one or more planes, characterised in that the filament sections are of varying lengths whereby the array approximates the cross-sectional shape of the light beam which is to be projected by the lamp.

2. The filament array of claim 1 wherein the cross-sectional shape of the beam is substantially circular.

3. A lamp including the filament array of claim 1 and a reflector.

4. The lamp of claim 3 wherein the reflector is spherical or part-spherical.
